(19) United States
(12) Patent Application Publication
(10) Pub. No.: US 2005/0101325 A1
(43) Pub. Date: May 12, 2005

(54) Efficient network messaging protocol for performing hard handoffs in a wireless network

(75) Inventor: William Joseph Semper, Richardson, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 10/919,586

(22) Filed: Aug. 17, 2004

Related U.S. Application Data
(60) Provisional application No. 60/514,322, filed on Oct. 24, 2003.

(51) Int. Cl. H04Q 7/20

(52) U.S. Cl. 455/436

(57) ABSTRACT

A first base station for use in a wireless network. The first base station receives a first control message from a second base station indicating that a first mobile station communicating with the second base station is about to be handed off to the first base station. The first base station, in response to the receipt of the first control message, generates a complete handoff control message and transmits the complete handoff control message to the second base station. The complete handoff control message is suitable for transmission by the second base station to the first mobile station to thereby cause the first mobile station to be handed off to the first base station. The complete handoff control message comprises a variable length Universal Handoff Direction message according to a CDMA2000 protocol.

### CROSS-REFERENCE TO RELATED APPLICATION AND CLAIM OF PRIORITY

The present invention is related to that disclosed in U.S. Provisional Patent Application Ser. No. 60/514,322, filed Oct. 24, 2003, entitled “Efficient Network Messaging Protocol for Performing Hard Handoffs in a Wireless Network”. U.S. Provisional Patent Application Ser. No. 60/514,322 is assigned to the assignee of the present application. The subject matter disclosed in U.S. Provisional Patent Application Ser. No. 60/514,322 is hereby incorporated by reference into the present disclosure as if fully set forth herein. The present invention hereby claims priority under 35 U.S.C. §119(e) to U.S. Provisional Patent Application Ser. No. 60/514,322.

### TECHNICAL FIELD OF THE INVENTION

The present invention relates generally to wireless networks and, more specifically, to an efficient and accurate method by which base stations in a CDMA2000 wireless network perform a hard handoff of a mobile call.

### BACKGROUND OF THE INVENTION

Wireless service providers continually try to create new markets for wireless devices and expand existing markets by making wireless devices and services cheaper and more reliable. One way to improve wireless devices and services is to reduce the cost of improving or upgrading the wireless network infrastructure. This may be achieved in part by designing the wireless network infrastructure in such a way that modification of one part of the network has no impact, or at most minimal impact, on other parts of the network. Unfortunately, this is not easily achieved. Quite often, modifying one component of a wireless network requires making corresponding modifications to several other components because of the interdependence of the various components.

This is particularly true of the messaging protocols that enable components of a wireless network infrastructure to communicate. A base station (BS) and a mobile switching center (MSC) communicate with one another according to standard protocols. Occasionally, if one control message is modified, several other control messages must also be modified. One example of the interdependence of control messages in a wireless network is the Universal Handoff Direction message (UHDM). When it is necessary to perform a hard handoff of a mobile station (e.g., a cell phone) from a source base station (BS) to a target base station (BS), a UHDM is transmitted over the air interface from the source base station to the mobile station.

The UHDM contains the essential radio parameters associated with the target base station that the mobile station will access and communicate with after the hard handoff is performed. In a conventional wireless network, the source base station gathers the radio parameters contained in the UHDM from the target base station by exchanging several different base station-to-base station (BS-BS) control messages (i.e., network signaling messages) according to the standards. After all of the required radio parameters have been received from the target base station, the source base station assembles (or generates) the Universal Handoff Direction message and transmits the UHDM to the mobile station.

Unfortunately, these conventional wireless networks are not forward compatible. Each time the UHDM is modified (e.g., new fields are added) in the air interface standard, several other base station-to-base station (BS-BS) network signaling messages (e.g., Handoff Request Acknowledgment message, Handoff Command message) also must be updated to reflect the modifications made to the UHDM. Thus, changes must also be made to each base station that communicates with the mobile switching center. Additional changes must also be made to the mobile switching center to accommodate the new network messages.

Therefore, there is a need in the art for an improved wireless network infrastructure that is more forward compatible than conventional wireless networks. In particular, there is a need for improved wireless network messaging by which the UHDM air interface message may be modified without requiring corresponding changes to multiple BS-BS network signaling messages.

### SUMMARY OF THE INVENTION

In the proposed invention, the target base station actually codes (or generates) the Universal Handoff Direction message (UHDM) for a CDMA2000 (IS-2000) network. Therefore, as new fields are added to the UHDM in future revisions, it is not necessary to modify the network signaling messages to support each new added field. The new UHDM fields in the Handoff Request Acknowledgment message and Handoff Command message are coded to include a variable length UHDM in its entirety, not just individual fields. In this manner, the present invention may be used to ensure forward-compatible software for future wireless radio access networks. Thus, once the BS-MSC interface of each base station is modified to accommodate variable length UHDM messages and the BS-MSC interfaces of the mobile switching center are modified to accommodate variable length UHDM messages, no further changes are required to the network signaling messages in the future.

To address the above-discussed deficiencies of the prior art, it is a primary object of the present invention to provide a first base station for use in a wireless network. According to an advantageous embodiment of the present invention, the first base station receives a first control message from a second base station indicating that a first mobile station communicating with the second base station is about to be handed off to the first base station. The first base station, in response to the receipt of the first control message, generates a complete handoff control message and transmits the complete handoff control message to the second base station.

According to one embodiment of the present invention, the complete handoff control message is suitable for transmission by the second base station to the first mobile station to thereby cause the first mobile station to be handed off to the first base station.

According to another embodiment of the present invention, the complete handoff control message comprises a first Universal Handoff Direction message according to a CDMA2000 protocol.

According to still another embodiment of the present invention, the first Universal Handoff Direction message is of variable length.

According to yet another embodiment of the present invention, the first control message received from the second base station comprises first handoff control information associated with the first mobile station and the second base station.

According to a further embodiment of the present invention, the first base station uses the first handoff control information contained in the first control message to generate the first Universal Handoff Direction message.

According to a still further embodiment of the present invention, the first base station is capable of transmitting to the second base station a second control message indicating that a second mobile station communicating with the first base station is about to be handed off to the second base station, the second control message comprising second handoff control information associated with the second mobile station and the first base station.

According to a yet further embodiment of the present invention, the first base station is capable of receiving from the second base station a second Universal Handoff Direction message in response to the second control message, and wherein the first base station is capable of transmitting the second Universal Handoff Direction message to the second mobile station to thereby cause the second mobile station to be handed off to the second base station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which base stations use an efficient network messaging protocol to perform hard handoffs of mobile stations according to the principles of the present invention;

FIG. 2 is a message flow diagram illustrating the operation of the present invention;

FIG. 3 illustrates a new Information Element to be used in the Handoff Required and Handoff Request messages according to the principles of the present invention; and

FIG. 4 illustrates new Information Element to be used in the Handoff Request Acknowledgment and Handoff Command messages according to the principles of the present invention.

### DETAILED DESCRIPTION OF THE INVENTION

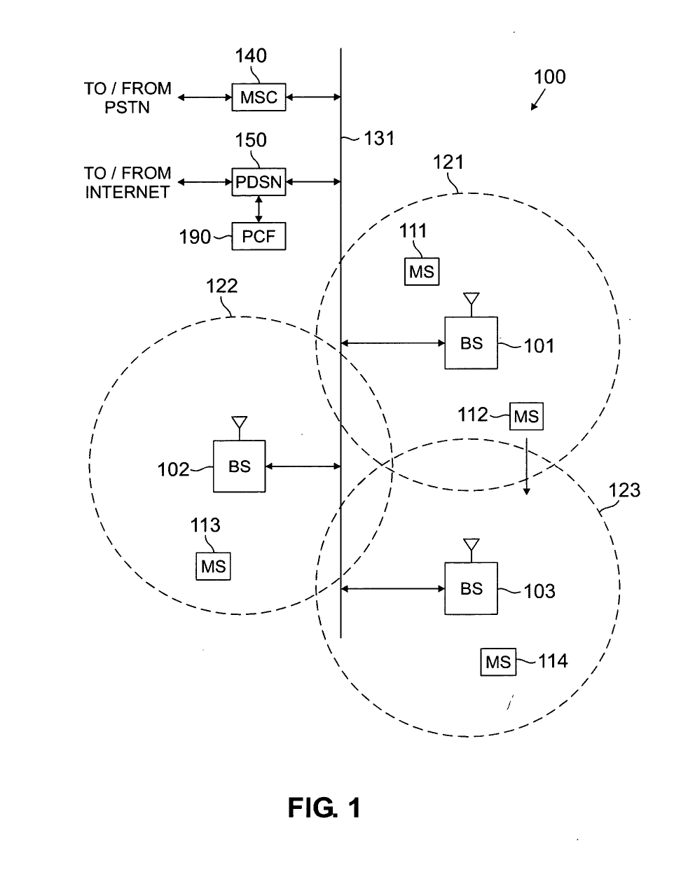

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100 in which base stations use an efficient network messaging protocol to perform hard handoffs of mobile stations according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 using, for example, the CDMA2000 air interface standard. In an advantageous embodiment of the present invention, mobile stations 111-114 are capable of receiving data traffic and/or voice traffic on two or more channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to communicating with mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a vending machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

According to the principles of the present invention, the base stations operating in wireless network 100 are capable of performing hard handoffs of a mobile station from a source base station to a target base station using a Universal Handoff Direction message (UHDM) that is composed (or assembled) by the target base station. The target BS then transmits the entire variable-length UHDM to the source (or originating) base station. The source base station then transmits the received UHDM to the mobile station in order to perform the handoff. The message flow changes slightly depending on whether or not the source. BS and the target BS are coupled to the same MSC or are coupled to different MSCs in different wireless networks.

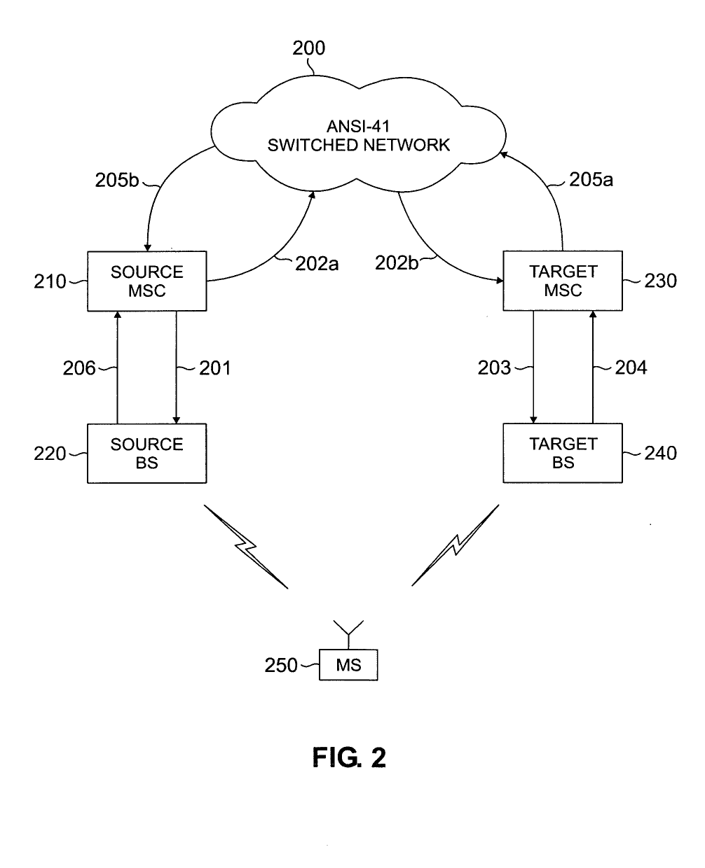

FIG. 2 is a message flow diagram illustrating the operation of the present invention. FIG. 2 illustrates selected portions of a CDMA2000 radio access network similar to the one shown in FIG. 1. Initially, mobile station (MS) 250 is communicating with source base station (BS) 220 and is moving towards target base station (BS) 240. Source base station 220 is connected to source mobile switching center (MSC) 210 and target base station 240 is connected to target mobile switching center (MSC) 230. In an alternate embodiment of the present invention, source BS 210 and target BS 240 may be connected to the same MSC.

At some point, mobile station (MS) 250 sends messages to source BS 220 indicating that a handoff to target BS 240 is about to occur. To accomplish this, source base station 220 uses a Universal Handoff Direction Message (UHDM) to instruct mobile station 250 to tune to target base station 240. However, most of the fields in the UHDM carry RF parameter information (data rate, Walsh codes, modulation scheme, etc.) that must be obtained from target base station 240. These RF parameters are used by MS 250 to communicate with target BS 240 after the handoff is completed. Therefore, messaging between source base station 220 and target base station 240 is required.

To obtain the information required to transmit the UHDM to MS 250, source base station 220 sends Handoff Required message 201 to source MSC 210. If source BS 220 and target BS 240 are coupled to different mobile switching centers of different wireless networks, source MSC 210 forwards Handoff Required message 201 over ANSI-41 switched network 200 to target MSC 230 to which target BS 240 is connected using messages 202a and 202b. If target BS 240 is connected directly to source MSC 210, messages 202a and 202b are not needed.

Target MSC 230 then sends Handoff Request message 203 to target BS 240. Handoff Request message 203 contains any fields of the UHDM that have been filled in by source BS 220, as well as other information about MS 250 and the call being handed off. Target BS 240 then fills in the remaining fields of the UHDM (including any information passed over from source BS 220), so that target BS 240 generates the UHDM exactly as the UHDM is to be sent over the air by source BS 220.

Target BS 240 sends the completed UHDM back to target MSC 230 via Handoff Request Acknowledgment message 204. If source BS 220 and target BS 240 are coupled to different mobile switching centers, the UHDM is then relayed through ANSI-41 switched network 200 to source MSC 210 via messages 205a and 205b. If source BS 220 and target BS 240 are coupled to the same MSC (i.e., MSC 210), messages 205a and 205b are not necessary. Source MSC 210 then forwards the UHDM to source base station 220 via Handoff Command message 206. Source base station 220 then transmits the UHDM to MS 250 and the handoff operation commences.

The Handoff Required message, the Handoff Request message, the Handoff Request Acknowledgment message, and the Handoff Command message are sent between base stations and mobile switching centers to signal the handoff of a mobile station. These messages are made up of a number of Information Elements, each of which carries specific information related to the mobile station being handed off. These information elements are several octets in length and are uniquely identified by an Information Element Identifier.

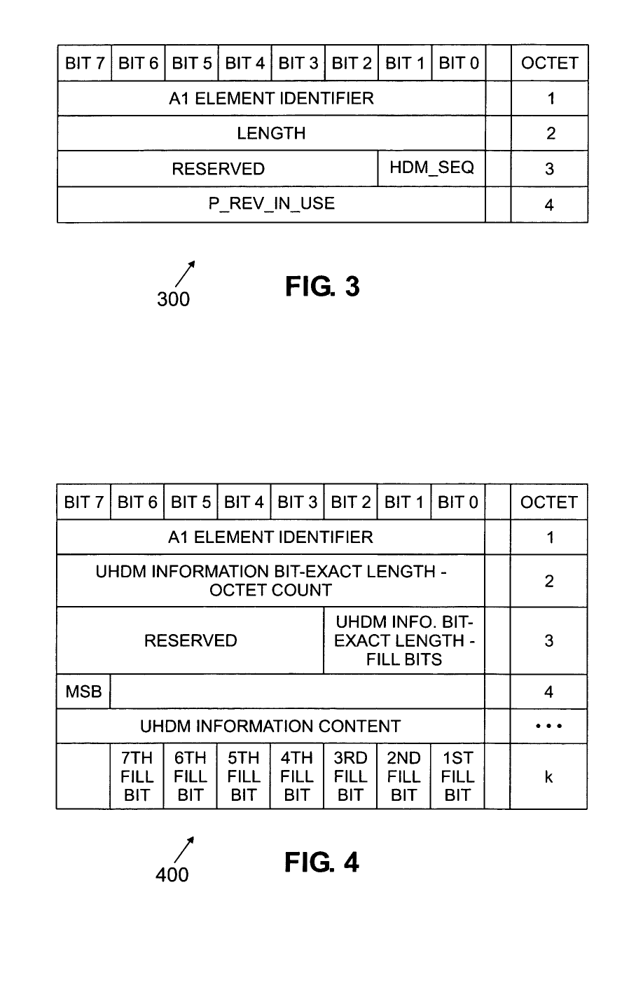

FIG. 3 illustrates new Information Element 300 to be used in Handoff Required messages and Handoff Request messages according to the principles of the present invention. Information Element 300 includes information for the UHDM that only source base station 220 knows. Target base station 240 uses this information to fully encode the UHDM, which target base station 240 then sends back to source base station 220. Information Element 300 comprises: i) an A1 Element Identifier field, ii) a Length field, iii) an HDM_SEQ field, and iv) a P_REV_IN_USE field.

The A1 Element Identifier field is a unique number assigned by the standards groups to identify Information Element 300. The Length field indicates the length of the remainder of Information Element 300 in octets. The HDM_SEQ field is set to the value of HDM-SEQ as defined in the TIA-2000-C, “CDMA2000 Spread Spectrum Systems”, May 2002. The P_REV_IN_USE field is set to the value of P_REV_IN_USE for the call as defined in the TIA-2000-C standard.

FIG. 4 illustrates new Information Element 400 to be used in Handoff Request Acknowledgment messages and Handoff Command messages according to the principles of the present invention. Information Element 400 includes the coding for the UHDM that target base station 240 sends back to source base station 220. Source base station 220 then sends the received UHDM over the air to mobile station 250 to initiate the handoff. Information Element 400 comprises: i) an A1 Element Identifier field, ii) a UHDM Information Bit-Exact Length—Octet Count field, iii) a UHDM Information Bit-Exact Length field, iv) a UHDM Information Content field, and v) N fill bits.

The A1 Element Identifier field is a unique number assigned by the standards groups to identify Information Element 400. The UHDM Information Bit-Exact Length—Octet Count field contains the total number of octets in the UHDM Information Content field represented as a binary value. The UHDM Information Bit-Exact Length—Fill Bits field contains a binary value indicating the number of fill bits contained in the last octet used for the UHDM Information Content field. The UHDM Information Content field is coded per section 3.7.3.3.2.36 of the TIA-2000-C standard. Finally, the N Fill Bits, if needed, are in Octet k. If the UHDM Information Bit-Exact Length—Fill Bits field contains a non-zero value, the indicated number of fill bits are set to Logic 0 and occupy the low-order bit positions of the last octet used for the UHDM Information Content field.

Although the present invention has been described with an exemplary embodiment, various changes and modifications may be suggested to one skilled in the art. It is intended that the present invention encompass such changes and modifications as fall within the scope of the appended claims.

1. For use in a wireless network, a first base station capable of receiving a first control message from a second base station indicating that a first mobile station communicating with said second base station is about to be handed off to said first base station, wherein said first base station, in response to said receipt of said first control message, generates a complete handoff control message and transmits said complete handoff control message to said second base station.

2. The first base station as set forth in claim 1, wherein said complete handoff control message is suitable for transmission by said second base station to said first mobile station to thereby cause said first mobile station to be handed off to said first base station.

3. The first base station as set forth in claim 2, wherein said complete handoff control message is of variable length.

4. The first base station as set forth in claim 2, wherein said complete handoff control message comprises a first Universal Handoff Direction message according to a CDMA2000 protocol.

5. The first base station as set forth in claim 4, wherein said first Universal Handoff Direction message is of variable length.

6. The first base station as set forth in claim 5, wherein said first control message received from said second base station comprises first handoff control information associated with said first mobile station and said second base station.

7. The first base station as set forth in claim 6, wherein said first base station uses said first handoff control information contained in said first control message to generate said first Universal Handoff Direction message.

8. The first base station as set forth in claim 7, wherein said first base station is capable of transmitting to said second base station a second control message indicating that a second mobile station communicating with said first base station is about to be handed off to said second base station, said second control message comprising second handoff control information associated with said second mobile station and said first base station.

9. The first base station as set forth in claim 8, wherein said first base station is capable of receiving from said second base station a second Universal Handoff Direction message in response to said second control message.

10. The first base station as set forth in claim 9, wherein said first base station is capable of transmitting said second Universal Handoff Direction message to said second mobile station to thereby cause said second mobile station to be handed off to said second base station.

11. A wireless network comprising a plurality of base stations, each one of said plurality of base stations capable of communicating with mobile stations accessing said wireless network, wherein a first one of said plurality of base stations is capable of receiving a first control message from a second one of said plurality of base stations indicating that a first mobile station communicating with said second base station is about to be handed off to said first base station, and wherein said first base station, in response to receipt of said first control message, generates a complete handoff control message and transmits said complete handoff control message to said second base station.

12. The wireless network as set forth in claim 11, wherein said complete handoff control message is suitable for transmission by said second base station to said first mobile station to thereby cause said first mobile station to be handed off to said first base station.

13. The wireless network as set forth in claim 12, wherein said complete handoff control message is of variable length.

14. The wireless network as set forth in claim 12, wherein said complete handoff control message comprises a first Universal Handoff Direction message according to a CDMA2000 protocol.

15. The wireless network as set forth in claim 14, wherein said first Universal Handoff Direction message is of variable length.

16. The wireless network as set forth in claim 15, wherein said first control message received from said second base station comprises first handoff control information associated with said first mobile station and said second base station.

17. The wireless network as set forth in claim 16, wherein said first base station uses said first handoff control information contained in said first control message to generate said first Universal Handoff Direction message.

18. The wireless network as set forth in claim 17, wherein said first base station is capable of transmitting to said second base station a second control message indicating that a second mobile station communicating with said first base station is about to be handed off to said second base station, said second control message comprising second handoff control information associated with said second mobile station and said first base station.

19. The wireless network as set forth in claim 18, wherein said first base station is capable of receiving from said second base station a second Universal Handoff Direction message in response to said second control message.

20. The wireless network as set forth in claim 19, wherein said first base station is capable of transmitting said second Universal Handoff Direction message to said second mobile station to thereby cause said second mobile station to be handed off to said second base station.

21. For use in a wireless network, a method of performing a handoff comprising the steps of:
receiving in a first base station a first control message from a second base station indicating that a first mobile station communicating with the second base station is about to be handed off to said first base station;
in response to receipt of the first control message, generating in the first base station a complete handoff control message;
transmitting the complete handoff control message to the second base station; and
transmitting the complete handoff control message from the second base station to the first mobile station to thereby cause the first mobile station to be handed off to the first base station.

22. The method as set forth in claim 21, wherein the complete handoff control message is of variable length.

23. The method as set forth in claim 21, wherein the complete handoff control message comprises a first Universal Handoff Direction message according to a CDMA2000 protocol.

24. The method as set forth in claim 23, wherein the first Universal Handoff Direction message is of variable length.

25. The method as set forth in claim 24, wherein the first control message received from the second base station comprises first handoff control information associated with the first mobile station and the second base station.
